(19) United States
(12) Patent Application Publication
(10) Pub. No.: US 2026/0213468 A1
(43) Pub. Date: Jul. 23, 2026

(54) CONNECTOR

(71) Applicant: JAPAN AVIATION ELECTRONICS INDUSTRY, LIMITED, Tokyo (JP)

(72) Inventors: Kazuki ISHII, Tokyo (JP); Takeharu NAITO, Tokyo (JP)

(73) Assignee: JAPAN AVIATION ELECTRONICS INDUSTRY, LIMITED, Tokyo (JP)

(21) Appl. No.: 19/411,274

(22) Filed: Dec. 7, 2025

(30) Foreign Application Priority Data
Jan. 20, 2025 (JP) 2025-007338

(51) Int. Cl. H01R 13/6592; H01R 11/28; H01R 13/02; H01R 13/58

(52) U.S. Cl. CPC H01R 13/6592; H01R 11/28; H01R 13/025; H01R 13/5808

(57) ABSTRACT

A connector is configured to be attached to a cable which includes at least one core wire, an insulation portion covering the core wire, a shield portion covering the insulation portion and a sheath covering the shield portion and being made of resin having flexibility. The connector includes a fixable member. The fixable member has a fixable portion. The fixable portion is configured to be wound around and fixed on the sheath of the cable. The fixable portion has a surface configured to be brought into contact with the sheath. The surface of the fixable portion is formed with a serration formed of a plurality of recessed portions. Each of the recessed portions extends in an axial direction of the cable.

### CROSS REFERENCE TO RELATED APPLICATIONS

This application is based on and claims priority under 35 U.S.C. § 119 to Japanese Patent Application No. JP 2025-007338 filed Jan. 20, 2025, the content of which is incorporated herein in its entirety by reference.

### BACKGROUND OF THE INVENTION

This invention relates to a connector configured to be attached to a cable.

For example, this type of connector is disclosed in JP2019-515452A (Patent Document 1), the content of which is incorporated herein by reference. Referring to FIG. 14, Patent Document 1 discloses a connector 90

configured to be attached to a cable 95. The cable 95 comprises a center conductor (core wire) 96, a dielectric layer (insulation portion) 97 covering the core wire 96, a conductive shield layer (shield portion) 98 covering the insulation portion 97 and a cable jacket (sheath) 99 covering the shield portion 98. The connector 90 comprises various unillustrated members such as a housing, an outer contact, etc. in addition to a center contact 91 and a ferule (sleeve) 92 both illustrated in FIG. 14. The sleeve 92 has a fixable portion 93. The fixable portion 93 is formed with a serration 94 consisting of a plurality of projections each of which extends in a circumferential direction of the cable 95. The fixable portion 93 of the sleeve 92 is crimped on, or wound around and pressed against, the sheath 99 of the cable 95 when the connector 90 is attached to the cable 95.

In general, a connector can be securely attached to a cable by forcibly crimping its fixable portion formed with a serration on the sheath of the cable. However, the forcibly crimped fixable portion compresses the insulation portion of the cable and thereby reduces a distance between the core wire and the shield portion. As a result, characteristic impedance of the cable might be lowered from a designed value.

### SUMMARY OF THE INVENTION

It is therefore an object of the present invention to provide a connector having a fixable portion which can be fixed on a sheath of a cable while reducing change in characteristic impedance of the cable.

An aspect of the present invention provides a connector configured to be attached to a cable which comprises at least one core wire, an insulation portion covering the core wire, a shield portion covering the insulation portion and a sheath covering the shield portion and being made of resin having flexibility. The connector comprises a fixable member. The fixable member has a fixable portion. The fixable portion is configured to be wound around and fixed on the sheath of the cable. The fixable portion has a surface configured to be brought into contact with the sheath, the surface of the fixable portion being formed with a serration having a plurality of recessed portions. Each of the recessed portions extends in an axial direction of the cable.

According to an aspect of the present invention, the fixable portion, which is configured to be fixed on the sheath of the cable, is provided with the serration having a plurality of the recessed portions each extending in the axial direction of the cable. When the fixable portion is wound around the sheath, the flexible sheath is partially deformed and is received in the recessed portions. As a result, the fixable portion is fixed on the sheath so as to grab the sheath in a circumferential direction of the cable. According to the aforementioned fixation method, the fixable portion can be securely fixed on the sheath while the sheath receives substantially no force which is directed inward in a radial direction of the cable. Accordingly, the insulation portion of the cable is not substantially deformed, and characteristic impedance of the cable is not substantially changed. An aspect of the present invention provides a connector having a fixable portion which can be fixed on a sheath of a cable while reducing change in characteristic impedance of the cable.

An appreciation of the objectives of the present invention and a more complete understanding of its configuration may be had by studying the following description of the preferred embodiment and by referring to the accompanying drawings.

### BRIEF DESCRIPTION OF THE DRAWINGS

FIG. 1 is a perspective view showing a connector according to an embodiment of the present invention, wherein the connector is attached to a cable.

FIG. 2 is an exploded, perspective view showing the connector and the cable of FIG. 1, wherein the illustrated front end part of the cable has a shape when attached to the connector.

FIG. 3 is a perspective view showing a sleeve of the connector of FIG. 2, wherein a center axis of a partial cylinder of the sleeve is illustrated with chain dotted line.

FIG. 4 is a side view showing the sleeve of FIG. 3.

FIG. 5 is a top view showing the sleeve of FIG. 3, wherein the center axis of the partial cylinder is illustrated with chain dotted line.

FIG. 6 is a front view showing the sleeve of FIG. 3.

FIG. 7 is a side view showing the sleeve and the cable of FIG. 2, wherein the cable is located between two half pieces of the sleeve, an end part of the cable is under a state where the sleeve is not yet fixed thereon, and an outline of a part of the cable hidden behind its shield portion is illustrated with dashed line.

FIG. 8 is a cross-sectional view showing the sleeve and the cable of FIG. 7, taken along line VIII-VIII.

FIG. 9 is a cross-sectional view showing a part of the sleeve and the cable enclosed by dashed line A of FIG. 8.

FIG. 10 is a side view showing the sleeve and the cable of FIG. 7, wherein the sleeve is fixed on the cable, and outlines of hidden recessed portions of the sleeve are partially illustrated with dashed line.

FIG. 11 is a cross-sectional view showing the sleeve and the cable of FIG. 10, taken along line XI-XI, wherein an outline of an upper part of the cable of FIG. 8 is illustrated with dashed line.

FIG. 12 is a cross-sectional view showing a part of the sleeve and the cable enclosed by dashed line B of FIG. 11.

FIG. 13 is a side view showing members including the sleeve and the cable of FIG. 10 and including an inner shell attached to the cable.

FIG. 14 is a perspective view showing a part of connector of Patent Document 1 together with a cable.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

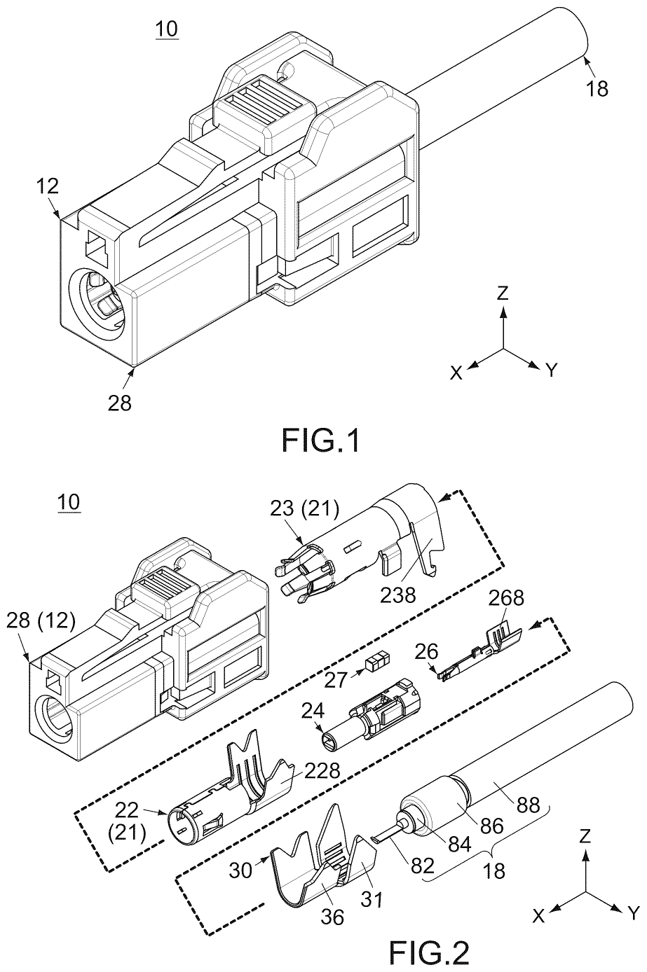

Referring to FIG. 1, a connector assembly 10 of an embodiment of the present invention comprises a connector 12 and a cable 18. The connector 12 of the present embodiment is an intermediate connector. The connector 12 is attached to a front end part of the cable 18 in a front-rear direction and is mateable along the front-rear direction with an object (not shown) which is located forward thereof.

The connector assembly 10 of the present embodiment has the aforementioned structure. However, the present invention is not limited thereto. For example, the connector assembly 10 may further comprise another member in addition to the connector 12 and the cable 18. The function of the connector 12 is not specifically limited.

The front-rear direction of the present embodiment is the X-direction. In the present embodiment, “forward” means the positive X-direction, and “rearward” means the negative X-direction. The words such as the front-rear direction do not indicate the absolute positional relation relative to the ground but merely indicate a relative positional relation under a definition that an axial direction along which the unbent cable 18 extends straight is the front-rear direction. Thus, the axial direction of the illustrated cable 18 is the front-rear direction (X-direction).

Hereafter, explanation will be made about the cable 18 and the connector 12 of the present embodiment.

Referring to FIG. 2, the cable 18 of the present embodiment is a typical coaxial cable. More specifically, the cable 18 comprises one core wire 82 made of conductor, an insulation portion 84 made of insulator, a shield portion 86 made of conductor and a sheath 88 made of insulator.

The cable 18 has a circular shape in a vertical plane (YZ-plane) perpendicular to the axial direction (front-rear direction). The core wire 82 is located at the center of the cable 18 in the vertical plane and has a circular shape in the vertical plane. The insulation portion 84, the shield portion 86 and the sheath 88 are arranged on concentric circles, respectively. These concentric circles have the same center as the core wire 82. The insulation portion 84 is made of elastically deformable material. The insulation portion 84 encloses and covers the core wire 82 in the vertical plane. The shield portion 86 encloses and covers the insulation portion 84 in the vertical plane. The sheath 88 is made of elastically deformable material. The sheath 88 encloses and covers the shield portion 86 in the vertical plane.

The number of the core wire 82 of the present embodiment is one. Each of the insulation portion 84 and the sheath 88 is made of resin having flexibility and is elastically deformed easily when a force is applied thereto. The shield portion 86 is made of material such as metal foil or a braid formed of metal fine wires.

The cable 18 of the present embodiment has the aforementioned structure. However, the cable 18 of the present invention is not limited to the cable 18 of the present embodiment, provided that the cable 18 comprises the core wire 82, the insulation portion 84 covering the core wire 82 in the vertical plane (YZ-plane), the shield portion 86 covering the insulation portion 84 in the vertical plane and the sheath 88 covering the shield portion 86 in the vertical plane.

For example, the cable 18 may have an ellipse shape or any other shapes in the vertical plane (YZ-plane). The number of the core wire 82 may be two or more. More specifically, the cable 18 may be a twisted pair cable or a parallel pair cable. The cable 18 may be a complex cable such as a high-definition multimedia interface (HDMI) cable. Thus, the sheath 88 does not need to be in close contact with and cover a surface of the one shield portion 86 but may be apart from and may enclose one or more of the shield portions 86. However, the present invention is suitable for a cable such as the cable 18 of the present embodiment in which the shield portion 86 is in contact with the insulation portion 84 and covers the insulation portion 84, and the sheath 88 is in contact with the shield portion 86 and covers the shield portion 86.

As shown in FIG. 2, the cable 18 of the present embodiment has the front end part from which the sheath 88 is removed. The core wire 82, the insulation portion 84 and the shield portion 86 of the front end part of the cable 18 are exposed from the sheath 88. The connector 12 is configured to be attached to the front end part of the cable 18 which is formed as described above. Thus, the connector 12 is configured to be attached to the cable 18 which comprises the at least one core wire 82, the insulation portion 84 covering the core wire 82, the shield portion 86 covering the insulation portion 84 and the sheath 88 covering the shield portion 86 and being made of resin having flexibility.

The connector 12 of the present embodiment comprises a ground shell 21, an inner housing 24 made of insulator, a contact 26 made of metal, a retainer 27 made of insulator, an outer housing 28 made of insulator and a sleeve 30 made of metal. The ground shell 21 of the present embodiment includes an inner shell (ground shell) 22 made of metal and an outer shell (ground shell) 23 made of metal. The inner shell 22 has an open barrel portion 228. The outer shell 23 has an open barrel portion 238. The contact 26 has an open barrel portion 268 located at a rear end part thereof. The contact 26 also has a front end part which can receive a pin (not shown).

The sleeve 30 of the present embodiment works as a fixable member 30 configured to be fixed on the sheath 88 of the cable 18. In other words, the connector 12 comprises the fixable member 30. The fixable member 30 of the present embodiment is configured to be fixed on the cable 18 together with the ground shell 21, and thereby the connector 12 is configured to be attached to the cable 18.

The connector 12 of the present embodiment is a receptacle formed of the aforementioned members. However, the structure of the connector 12 is not specifically limited, provided that the connector 12 comprises the fixable member 30. For example, the connector 12 may be a plug. The connector 12 may comprise only one of the ground shell 22 and the ground shell 23. Thus, the ground shell 21 may be a single member. The connector 12 may further comprise another member in addition to the aforementioned members. The structure of each member is not limited to the illustrated structure.

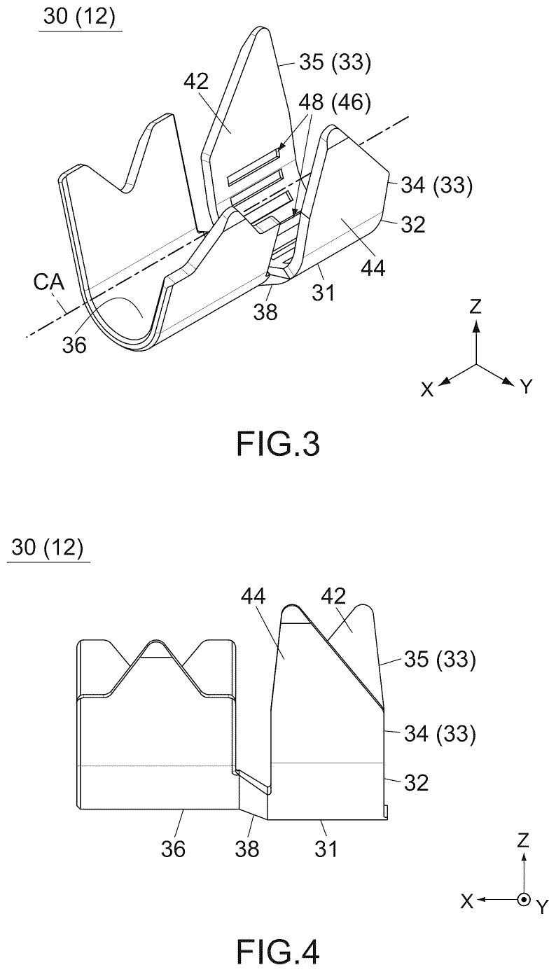

Referring to FIG. 2 together with FIGS. 3 and 4, the fixable member 30 of the present embodiment is formed by bending a single metal plate. In other words, the fixable member 30 is a single metal plate with bends. The fixable member 30 has a fixable portion 31, an additional fixable portion 36 and a coupling portion 38. The fixable portion 31 is a rear part of the fixable member 30. The additional fixable portion 36 is a front part of the fixable member 30. The coupling portion 38 is located at a lower end of the fixable member 30 in an up-down direction perpendicular to the front-rear direction and couples the fixable portion 31 and the additional fixable portion 36 together in the front-rear direction.

The up-down direction of the present embodiment is the Z-direction. In the present embodiment, “upward” means the positive Z-direction, and “downward” means the negative Z-direction.

Referring to FIGS. 3 to 6, the fixable portion 31 of the present embodiment has a partial cylinder 32 and two half pieces 33. The partial cylinder 32 has a partial cylindrical shape around an imaginary center axis CA which extends in parallel to the front-rear direction. The thus-shaped partial cylinder 32 projects downward. The partial cylinder 32 arranged as described above has two upper ends which are arranged in a lateral direction perpendicular to both the front-rear direction and the up-down direction. The lateral direction of the present embodiment is the Y-direction. Each of the half pieces 33 is a flat plate oblique to the up-down direction. The half pieces 33 extend upward from the upper ends of the partial cylinder 32, respectively.

The half pieces 33 include a first piece (half piece) 34 and a second piece (half piece) 35. The half piece 34 and the half piece 35 have shapes complementary to each other. More specifically, when the half piece 34 and the half piece 35 are bent around the center axis CA together with the partial cylinder 32, the half piece 34 and the half piece 35 can be combined together without overlapping with each other and thereby form a cylindrical part around the center axis CA.

Referring to FIG. 3 together with FIG. 2, as described above, the fixable portion 31 of the present embodiment has an open barrel shape, or a shape of a cylinder whose surface is cut in the front-rear direction and is opened. The additional fixable portion 36 of the present embodiment also has an open barrel shape. However, the present invention is not limited thereto. For example, the shape of each of the fixable portion 31 and the additional fixable portion 36 is not limited to the illustrated shape, provided that they can form parts which enclose and cover the sheath 88 and the shield portion 86 of the cable 18, respectively, by bending process. According to the present embodiment, each of the fixable portion 31 and the additional fixable portion 36 can form the cylindrical part by bending process.

The fixable member 30 of the present embodiment is the sleeve 30 which has the aforementioned structure. The sleeve 30 has the fixable portion 31 configured to be fixed on the sheath 88 of the cable 18 and thereby works as the fixable member 30. However, the present invention is not limited thereto. As described later, some member other than the sleeve 30 may work as a fixable member. In this instance, the sleeve 30 does not need to be provided. Moreover, in the present embodiment in which the sleeve 30 works as the fixable member 30, the additional fixable portion 36 and the coupling portion 38 may be provided as necessary.

Hereafter, explanation will be made about an attachment method of the present embodiment by which the connector 12 is attached to the cable 18. The attachment method described below is merely an example and can be modified as necessary.

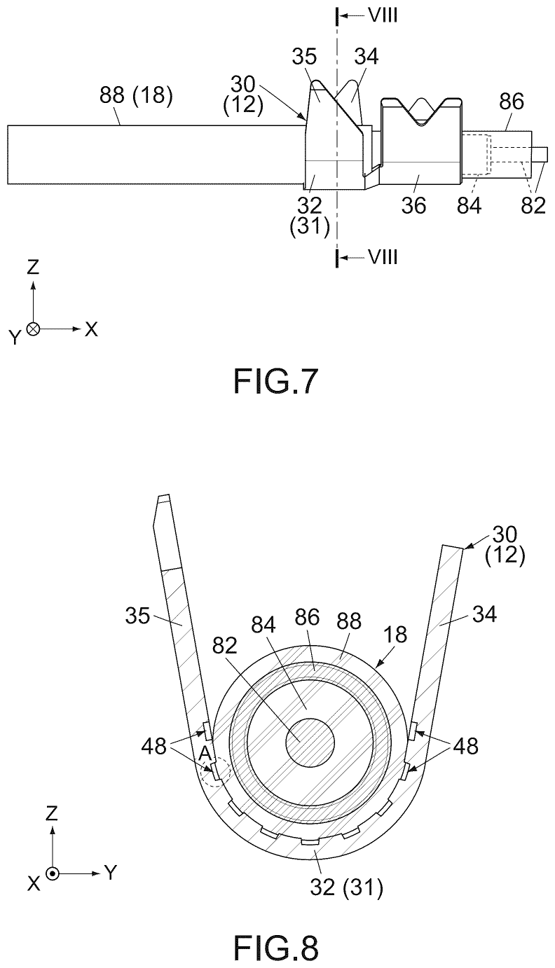

Referring to FIGS. 7 and 8, firstly, the core wire 82, the insulation portion 84 and the shield portion 86 of the front end part of the cable 18 are exposed from the sheath 88. Then, the front end part of the cable 18 is placed on the sleeve 30. In detail, a front end part of the remaining sheath 88 is located between the half piece 34 and the half piece 35 in the lateral direction and is pressed against the partial cylinder 32. Meanwhile, the exposed shield portion 86 is located between two pieces of the additional fixable portion 36 in the lateral direction.

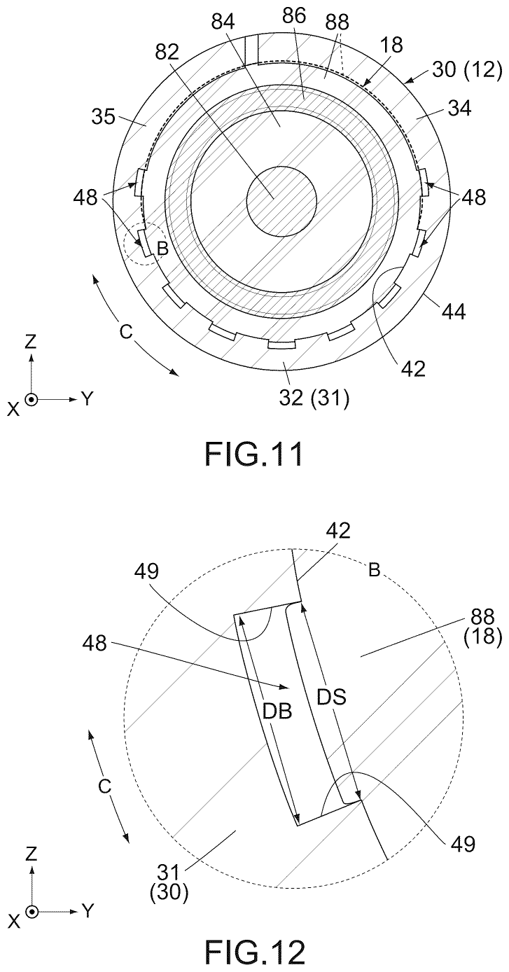

Referring to FIGS. 10 and 11 together with FIGS. 7 and 8, then, the sleeve 30 is wound around the front end part of the cable 18. In detail, the fixable portion 31 is crimped on, or is wound around and fixed on, the sheath 88 of the cable 18, and the additional fixable portion 36 is crimped on, or is wound around and fixed on, the shield portion 86 of the cable 18. Then, a part of the shield portion 86 which is located forward of the additional fixable portion 36 is folded back on the additional fixable portion 36. As a result, the sleeve 30 is fixed on the cable 18 as shown in FIGS. 10 and 11.

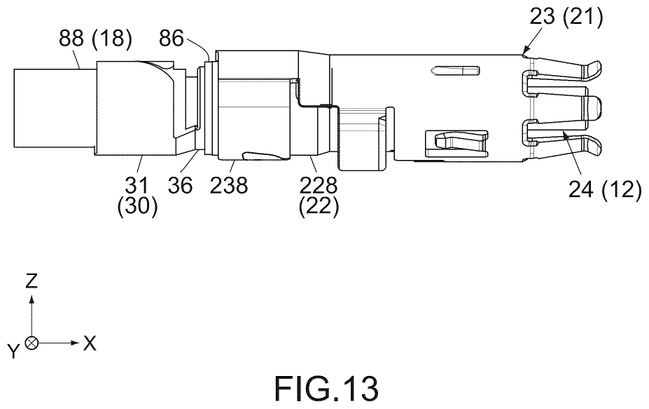

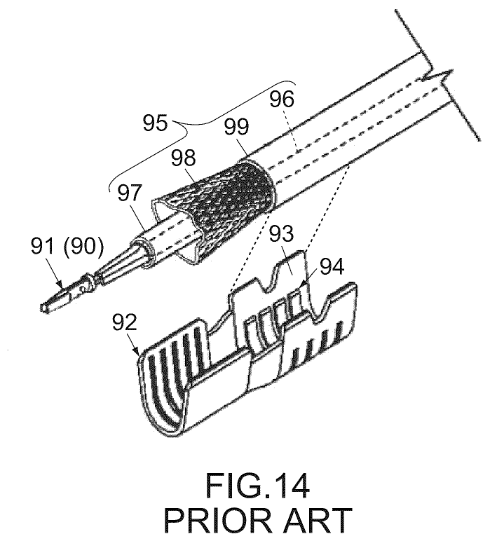

Referring to FIG. 2 together with FIG. 10, then, the open barrel portion 268 of the contact 26 is crimped on the core wire 82 of the cable 18. Then, the contact 26 is inserted into the inner housing 24. Then, the retainer 27 is inserted into the inner housing 24. As a result, the contact 26 is fixed in the inner housing 24. Then, the inner housing 24 is inserted into a cylindrical part of the inner shell 22. Then, the open barrel portion 228 of the inner shell 22 is crimped on the shield portion 86 of the cable 18 which is folded back on the additional fixable portion 36. Referring to FIG. 13, then, the open barrel portion 238 of the outer shell 23 is crimped on the open barrel portion 228 of the inner shell 22 which is formed into a cylindrical shape. At that time, the connector 12 is attached to the cable 18.

According to the present embodiment, the ground shell 21 and the sleeve 30 are electrically connected with each other when the connector 12 is attached to the cable 18. In detail, the shield portion 86 of the cable 18, the additional fixable portion 36 of the sleeve 30, the folded back part of the shield portion 86, the open barrel portion 228 of the inner shell 22 and the open barrel portion 238 of the outer shell 23 are located at concentric circles in the vertical plane (YZ-plane), respectively, and are in contact with each other. However, the present invention is not limited thereto. For example, the shield portion 86 does not need to be folded back on the additional fixable portion 36. In this instance, the additional fixable portion 36 and the open barrel portion 228 may be in direct contact with each other.

Referring to FIG. 2, in general, the cable 18 is designed so that its characteristic impedance is maintained at a predetermined designed value such as 50 Ω or 75 Ω. If the characteristic impedance of the cable 18 is changed from the designed value, high frequency signals transmitted through the core wire 82 of the cable 18 might be degraded in transmission characteristics. For example, when the members such as the sleeve 30 and the ground shell 21 are forcibly crimped on the cable 18, the insulation portion 84 of the cable 18 is compressed, and thereby a distance between the core wire 82 and the shield portion 86 is reduced. As a result, the characteristic impedance of the cable 18 might be lowered from the designed value.

In contrast, according to the attachment method of the present embodiment, the shield portion 86 and the ground shell 21 can be electrically connected with each other through various portions. Accordingly, electrical connection between the shield portion 86 and the ground shell 21 can be made reliable while the cable 18 is prevented from degradation in transmission characteristics which might be caused when each member is forcibly crimped. In addition, degradation of the cable 18 in transmission characteristics can be reduced by completely covering the front end part of the cable 18 with the various metal members.

According to the attachment method of the present embodiment, only the fixable portion 31 of the sleeve 30, which is formed separately from the ground shell 21, is crimped on the sheath 88 of the cable 18. However, the present invention is not limited thereto. For example, the sleeve 30 may comprise only the additional fixable portion 36. In this instance, a fixable portion (not shown) provided on the ground shell 21 may be crimped on the sheath 88 instead of the fixable portion 31 of the sleeve 30. A member other than the sleeve 30 and the ground shell 21 may have a fixable portion (not shown) which is configured to be crimped on the sheath 88.

Hereafter, further specific explanation will be made about the sleeve 30 of the present embodiment.

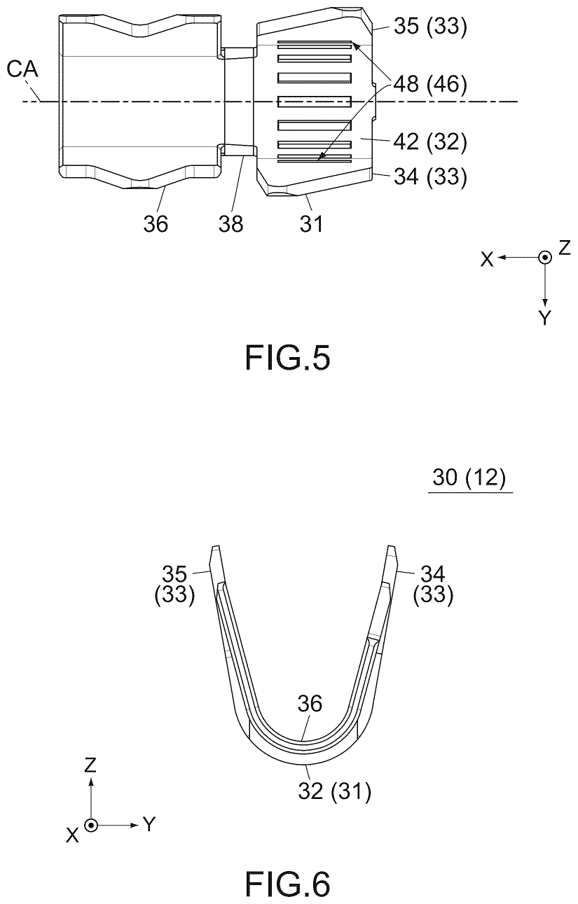

Referring to FIGS. 3 and 5, the fixable portion 31 of the sleeve 30 has a contact surface 42 and an outer surface 44. The contact surface 42 is an inner surface of the sleeve 30 in the vertical plane (YZ-plane), and the outer surface 44 is an outer surface of the sleeve 30 in the vertical plane. Referring to FIG. 11, the contact surface 42 is located inside the fixable portion 31 and is pressed against the sheath 88 in the vertical plane when the fixable portion 31 is wound around the sheath 88 of the cable 18. Thus, the contact surface 42 is located on an inner circumference of the fixable portion 31 in the vertical plane when the fixable portion 31 is formed into a cylindrical shape. The outer surface 44 is located on an outer circumference of the fixable portion 31 in the vertical plane when the fixable portion 31 is formed into a cylindrical shape.

Referring to FIGS. 3, 5 and 11, the contact surface 42 of the present embodiment is formed with nine recessed portions 48. The recessed portions 48 of the present embodiment are arranged at regular intervals around the center axis CA and extend along the center axis CA in parallel to each other. Each of the recessed portions 48 is a depression formed in the contact surface 42 and has a bottom. The recessed portions 48 are located at the middle of the fixable portion 31 in the front-rear direction. Each of the recessed portions 48 has a rectangular shape in the contact surface 42. In other words, each of the recessed portions 48 is a rectangular groove extending along the center axis CA. The recessed portions 48 form a serration 46, or a pattern which is configured to reliably fix the fixable portion 31 on the sheath 88 of the cable 18. As described above, the fixable portion 31 has the contact surface 42, or a surface configured to be brought into contact with the sheath 88. The contact surface 42 of the fixable portion 31 is formed with the serration 46 having a plurality of the recessed portions 48. Each of the recessed portions 48 extends in the axial direction of the cable 18.

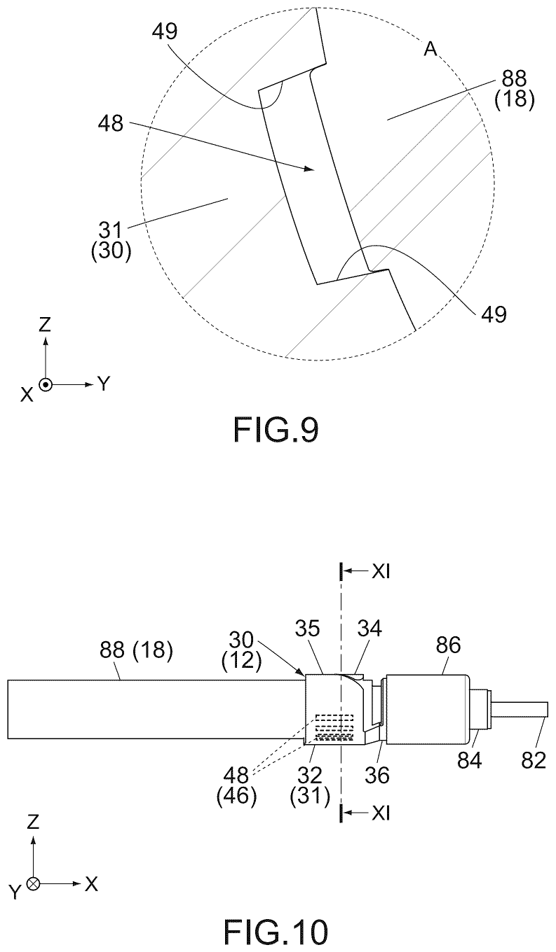

Referring to FIGS. 8 and 9, according to the present embodiment, the sheath 88 is located between the half piece 34 and the half piece 35 of the fixable portion 31 and is pressed against the partial cylinder 32 before the fixable portion 31 is wound around the sheath 88 of the cable 18. The thus-arranged flexible sheath 88 is partially deformed and is partially received in the seven recessed portions 48 of the nine recessed portions 48. Referring to FIGS. 11 and 12, when the fixable portion 31 is wound around the sheath 88 thereafter, the sheath 88 is further partially deformed and is partially received in all of the nine recessed portions 48. As a result, the fixable portion 31 is fixed on the sheath 88 so as to grab the sheath 88 in a circumferential direction C perpendicular to the axial direction of the cable 18.

In detail, referring to FIG. 12 together with FIG. 9, each of the recessed portions 48 has two wall surfaces 49 which extend along the axial direction of the cable 18 in parallel to each other. When the fixable portion 31 is wound around the sheath 88, in each of the recessed portions 48, a distance DS between the two wall surfaces 49 along the contact surface 42 becomes smaller than a distance DB between the two wall surfaces 49 along the bottom of the recessed portion 48, and the two wall surfaces 49 sandwich and hold a part of the sheath 88 received in the recessed portion 48 in the circumferential direction C.

According to the aforementioned fixation method, the fixable portion 31 can be securely fixed on the sheath 88 while the sheath 88 substantially receives no force which is directed inward in a radial direction of the cable 18. Referring to FIG. 11, a surface of the sheath 88 squeezed by the fixable portion 31 is slightly moved inward in the radial direction (see the sheath 88 illustrated by dashed line in FIG. 11). However, the force applied to the sheath 88 from the fixable portion 31 is used to compress and elastically deform the sheath 88, and thereby the insulation portion 84 of the cable 18 is not substantially deformed. Accordingly, a distance between the core wire 82 and the shield portion 86 of the cable 18 is not substantially changed, and thereby characteristic impedance of the cable 18 is not substantially changed. The present embodiment provides the connector 12 having the fixable portion 31 which can be fixed on the sheath 88 of the cable 18 while reducing change in characteristic impedance of the cable 18.

The number of the recessed portions 48 of the present embodiment is nine. The sheath 88 of the cable 18 can be easily grabbed by providing a large number of the recessed portions 48. However, the present invention is not limited thereto. For example, the number of the recessed portions 48 may be two or more.

The present embodiment can be further variously modified as described below in addition to the already described various modifications.

Referring to FIG. 3, each of the recessed portions 48 of the present embodiment is recessed from the contact surface 42 toward the outer surface 44 but does not pass through the fixable portion 31. However, the present invention is not limited thereto. For example, each of the recessed portions 48 may be a slit which passes through the fixable portion 31.

Each of the recessed portions 48 of the present embodiment extends straight along the axial direction of the cable 18 (see FIG. 10), or along the center axis CA. However, the present invention is not limited thereto. For example, each of the recessed portions 48 may be oblique to the axial direction (center axis CA) within the range of tolerance.

The recessed portions 48 of the present embodiment are arranged at regular intervals to each other in a circumferential direction around the center axis CA. However, the present invention is not limited thereto. For example, adjacent distances may be different from each other, wherein each of the adjacent distances is a distance between two of the recessed portions 48 adjacent to each other. Two or more of the recessed portions 48 may be arranged along the center axis CA with a slight distance formed therebetween. In this instance, each of the recessed portions 48 has a length in the center axis CA which is shorter than a width in the circumferential direction.

The contact surface 42 of the present embodiment is formed with no recess and no projection except for the recessed portions 48 each of which extends along the center axis CA. However, the present invention is not limited thereto. For example, the contact surface 42 may be formed with projections. Moreover, the contact surface 42 may be formed with additional recesses in addition to the recessed portions 48. Each of these additional recesses may extend along a direction intersecting with the center axis CA.

Each of the recessed portions 48 of the present embodiment extends without intersecting with the other recessed portion 48, the other recess and the other projection. Each of the recessed portions 48 has a width and a depth each of which is constant over the whole recessed portion 48. However, the present invention is not limited thereto. For example, each of the recessed portions 48 may intersect with the other recess. Each of the recessed portions 48 may have a width and a depth each of which is varied depending on the position of the recessed portion 48.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is

1. A connector configured to be attached to a cable which comprises at least one core wire, an insulation portion covering the core wire, a shield portion covering the insulation portion and a sheath covering the shield portion and being made of resin having flexibility, wherein:
the connector comprises a fixable member;
the fixable member has a fixable portion;
the fixable portion is configured to be wound around and fixed on the sheath of the cable;
the fixable portion has a surface configured to be brought into contact with the sheath, the surface of the fixable portion being formed with a serration having a plurality of recessed portions; and
each of the recessed portions extends in an axial direction of the cable.

2. The connector as recited in claim 1, wherein:
the connector comprises a ground shell and a sleeve;
the sleeve has the fixable portion and works as the fixable member; and
the ground shell and the sleeve are connected to each other when the connector is attached to the cable.
